(19) United States
(12) Patent Application Publication
(10) Pub. No.: US 2026/0265061 A1
(43) Pub. Date: Sep. 10, 2026

(54) CARBON MATERIAL, CATALYST, DISPERSION, ELECTRODE, BATTERY, AND ELECTROLYSIS DEVICE

(71) Applicants: DIC Corporation, Tokyo (JP); The University of Osaka, Osaka (JP)

(72) Inventors: Keisuke SAKAMOTO, Chiba (JP); Kengo YASUI, Ibaraki (JP); Yasuhiro SHIRAISHI, Osaka (JP); Takayuki HIRAI, Osaka (JP)

(21) Appl. No.: 19/166,632

(22) PCT Filed: Mar. 21, 2024
(86) PCT No.: PCT/JP2024/011147

§ 371 Date: Sep. 18, 2025

(30) Foreign Application Priority Data
Apr. 6, 2023 (JP) 2023-062253

(51) Int. Cl. C01B 32/05; B01J 21/18; B01J 23/06; B01J 23/745; B01J 27/10; B01J 27/128; B01J 35/33; B01J 35/61; B01J 35/63; B01J 35/64; B01J 37/08; C25B 11/043; H01M 4/587

(52) U.S. Cl. CPC C01B 32/05; B01J 21/18; B01J 23/06; B01J 23/745; B01J 27/10; B01J 27/128; B01J 35/33; B01J 35/615; B01J 35/617; B01J 35/618; B01J 35/633; B01J 35/635; B01J 35/638; B01J 35/647; B01J 37/086; C25B 11/043; H01M 4/587; C01P 2002/52; C01P 2002/74; C01P 2002/89; C01P 2006/12; C01P 2006/14; C01P 2006/16; C01P 2006/40; C01P 2006/80

(57) ABSTRACT

A carbon material containing at least carbon, nitrogen, and bromine as constituent elements, in which a bromine content as measured by a combustion ion chromatograph method is from 50 to 100000 ppm by mass, and the number of carbon atoms Cₓₚₛ and the number of nitrogen atoms Nₓₚₛ, both of which are quantified by X-ray photoelectron spectroscopy, satisfy 0.005≤Nₓₚₛ/Cₓₚₛ≤0.300.

### TECHNICAL FIELD

The present disclosure relates to a carbon material, a catalyst, a dispersion liquid, an electrode, a battery, and an electrolysis device.

### BACKGROUND ART

Carbon materials are used in a wide range of applications because of their characteristics such as high electrical conductivity, high thermal conductivity, low thermal expansion coefficient, lightness, and heat resistance. In recent years, the use of a carbon material containing nitrogen as a catalyst for a positive electrode (oxygen reduction catalyst) of a fuel cell or an air cell has been studied (see Patent Document 1). The carbon material containing nitrogen may have carbon dioxide reduction activity or nitrogen reduction activity, and also has attracted attention as a catalyst for a cathode (carbon dioxide reduction catalyst or nitrogen reduction catalyst) in an electrolysis device (see Non-Patent Document 1 and Non-Patent Document 2).

### CITATION LIST

### Patent Literature

Patent Document 1: JP 2012-101155 A
Patent Document 2: WO 2021/220495

### Non-Patent Literature

Non-Patent Document 1: Angew. Chem. Int. Ed., 2015, 54, 10758-10762
Non-Patent Document 2: Nature Communications, 2019, 10, 341-348

### SUMMARY OF INVENTION

### Technical Problem

An object of one aspect of the present disclosure is to provide a novel carbon material that can be used in an electrode catalyst.

### Solution to Problem

[1]

Some aspects of the present disclosure provide the following [1] to [21].

A carbon material containing at least carbon, nitrogen, and bromine as constituent elements, wherein
a bromine content as measured by a combustion ion chromatograph method is from 50 to 100000 ppm by mass, and
the number of carbon atoms Cₓₚₛ and the number of nitrogen atoms Nₓₚₛ, both of which are quantified by X-ray photoelectron spectroscopy, satisfy 0.005≤Nₓₚₛ/Cₓₚₛ≤0.300.

[2]

The carbon material according to [1], wherein the carbon material contains at least one metal element selected from the group consisting of Fe, Co, Ni, Cu, and Zn as a constituent element.

[3]

The carbon material according to [2], wherein a total content of the metal elements as measured by inductively coupled plasma-optical emission spectrometry is from 0.005 to 20 mass %.

[4]

The carbon material according to [2] or [3], wherein a content of the Fe element as measured by inductively coupled plasma-optical emission spectrometry is from 1 to 60000 ppm by mass.

[5]

The carbon material according to [2], wherein a content of the Zn element as measured by inductively coupled plasma-optical emission spectrometry is from 1 to 60000 ppm by mass.

[6]

The carbon material according to any one of [1] to [5], wherein in an N1s spectrum as measured by X-ray photoelectron spectroscopy, a peak intensity I₁ at 398.5±0.5 eV and a peak intensity I₂ at 401.2±0.5 eV satisfy 0.7≤I₂/I₁≤3.0.

[7]

The carbon material according to any one of [1] to [6], wherein the number of carbon atoms C_{CHN} and the number of nitrogen atoms N_{CHN}, both of which are quantified by CHN elemental analysis using a combustion method, satisfy 0.005≤N_{CHN}/C_{CHN}≤0.300.

[8]

The carbon material according to any one of [1] to [7], wherein the carbon material is a powdery material having porosity.

[9]

The carbon material according to [8], wherein a specific surface area as measured by a BET one point method is from 100 to 2000 m²/g.

[10]

The carbon material according to [8] or [9], wherein
the carbon material has micropores having a pore size of less than 2 nm, and a total volume of the micropores as measured by a nitrogen gas adsorption method is from 0.03 to 3.00 cm³/g.

[11]

The carbon material according to any one of [8] to [10], wherein
the carbon material has mesopores having a pore size of from 2 to 50 nm, and a total volume of the mesopores as measured by a nitrogen gas adsorption method is from 0.3 to 4.0 cm³/g.

[12]

The carbon material according to any one of [1] to [11], wherein an electrical conductivity is from 0.01 to 50 S/cm.

[13]

The carbon material according to any one of [1] to [12], wherein the carbon material is a fired product of a raw material containing a phthalocyanine compound having bromine as a substituent.

[14]

The carbon material according to [13], wherein the phthalocyanine compound contains Zn as a central metal.

[15]

The carbon material according to [13] or [14], wherein the raw material further contains a compound containing at least one metal element selected from the group consisting of Fe, Co, Ni, Cu, Al, and Zn.

[16]

A catalyst containing the carbon material described in any one of [1] to [15].

[17]

A dispersion liquid containing the carbon material described in any one of [1] to [15] and a dispersion medium for the carbon material.

[18]

The dispersion liquid according to [17], containing a polymer electrolyte.

[19]

An electrode containing an electrode catalyst layer containing the carbon material described in any one of [1] to [15].

[20]

A battery including the electrode described in [19].

[21]

An electrolysis device including the electrode described in [19].

### Advantageous Effects of Invention

According to one aspect of the present disclosure, a novel carbon material that can be used in an electrode catalyst can be provided.

### DESCRIPTION OF EMBODIMENTS

In the present specification, numerical ranges indicated using “to” indicate ranges that include numerical values described before and after “to” as a minimum value and a maximum value, respectively. In addition, unless otherwise specifically indicated, the units of the numerical values described before and after “to” are the same. In numerical ranges described stepwise in the present specification, an upper or lower limit of a numerical range at a stage may be replaced by an upper or lower limit of a numerical range at another stage. In a numerical range described herein, the upper or lower limit value of the numerical range may be replaced by a value presented in the examples (experimental examples). The upper limit values and the lower limit values described individually can be combined arbitrarily.

Hereinafter, preferred embodiments of the present disclosure will be described. However, the present disclosure is not limited to the following embodiments.

### (Carbon Material)

An embodiment of the present disclosure is a carbon material containing at least carbon (C), nitrogen (N), and bromine (Br) as constituent elements, wherein a bromine content as measured by a combustion ion chromatograph (CIC) method is from 50 to 100000 ppm by mass, and the number of carbon atoms Cₓₚₛ and the number of nitrogen atoms Nₓₚₛ, both of which are quantified by X-ray photoelectron spectroscopy (XPS), satisfy 0.005≤Nₓₚₛ/Cₓₚₛ≤0.300. Specific methods for measuring the bromine content and the elemental composition ratio Nₓₚₛ/Cₓₚₛ are described in the examples (experimental examples). Hereinafter, in the present specification, the Nₓₚₛ/Cₓₚₛ means a ratio of the number of carbon atoms Cₓₚₛ to the number of nitrogen atoms Nₓₚₛ, both of which are quantified by XPS.

The carbon material exhibits excellent oxygen reduction activity, and thus can be utilized in a catalyst for a reduction reaction of oxygen (oxygen reduction catalyst), and is used in an electrode catalyst such as a catalyst for a positive electrode of a fuel cell, an air cell, or the like, or a catalyst for a cathode of an oxygen electrolysis device, for example. The carbon material also tends to exhibit carbon dioxide reduction activity and nitrogen reduction activity. Therefore, the carbon material can also be utilized in a catalyst for a reduction reaction of carbon dioxide (carbon dioxide reduction catalyst) and a catalyst for a reduction reaction of nitrogen (nitrogen reduction catalyst). Specific applications include, for example, a catalyst for a cathode of a carbon dioxide electrolysis device and a nitrogen electrolysis device. The fact that the carbon material has oxygen reduction activity, carbon dioxide reduction activity, and nitrogen reduction activity can be confirmed by a method described in the examples (experimental examples).

The carbon material is a material mainly containing carbon (C), and a content of carbon in the carbon material is 60 mass % or more. The content of carbon in the carbon material can be measured by CHN elemental analysis using a combustion method. The content of carbon in the carbon material may be 70 mass % or more or 80 mass % or more.

The bromine content may be 500 ppm by mass or more or 2000 ppm by mass or more, and may be 50000 ppm by mass or less or 20000 ppm by mass or less, from the viewpoint of easily obtaining more excellent oxygen reduction activity.

From the viewpoint of easily obtaining more excellent oxygen reduction activity, the Nₓₚₛ/Cₓₚₛ may be 0.010 or more or 0.050 or more, and may be 0.220 or less or 0.140 or less.

In an N1s spectrum as measured by the XPS, a peak intensity 11 at 398.5±0.5 eV and a peak intensity 12 at 401.2±0.5 eV may satisfy 0.7≤I₂/I₁≤3.0. In this case, there is a tendency that more excellent oxygen reduction activity is obtained. The reason for this is presumed as follows. First, in the N1 s spectrum, the peak located at 398.5±0.5 eV is assigned to pyridine-type nitrogen, and the peak located at 401.2±0.5 ev is assigned to quaternary-type nitrogen. Therefore, the intensity ratio between both peaks corresponds to a ratio of the amount of the quaternary-type nitrogen to the amount of the pyridine-type nitrogen contained in the carbon material. It is presumed that nitrogen in the carbon material forms active sites for oxygen reduction, and it is presumed that when the amount of the pyridine-type nitrogen and the amount of the quaternary-type nitrogen are within predetermined ranges, the amount of active sites is well balanced, and that more excellent oxygen reduction activity is obtained. The peak intensity ratio I₂/I₁ may be 1.0 or more or 1.4 or more, and may be 2.0 or less or 1.5 or less, from the viewpoint of obtaining further excellent oxygen reduction activity.

In the carbon material, the number of carbon atoms C_{CHN} and the number of nitrogen atoms N_{CHN}, both of which are quantified by CHN elemental analysis using the combustion method, may satisfy 0.005≤N_{CHN}/C_{CHN}≤0.300, from the viewpoint of further improving the catalytic activity and the electrical conductivity. Hereinafter, in the present specification, the N_{CHN}/C_{CHN} means a ratio of the number of carbon atoms C_{CHN} to the number of nitrogen atoms N_{CHN}, both of which are quantified by CHN elemental analysis.

From the viewpoint of further improving the catalytic activity, the N_{CHN}/C_{CHN} may be 0.05 or more, or may be 0.08 or more. The N_{CHN}/C_{CHN} may be 0.2 or less, or may be 0.16 or less, from the viewpoint of electrical conductivity.

In the carbon material, a ratio of N_{XPS}/C_{XPS} to N_{CHN}/C_{CHN} is not particularly limited, but for example, [N_{XPS}/C_{XPS}]/[N_{CHN}/C_{CHN}] may be 0.7 or more, or may be 0.8 or more. When the [N_{XPS}/C_{XPS}]/[N_{CHN}/C_{CHN}] is within the above range, the activity of the catalyst becomes more excellent. This is presumably because of the following reasons. It is generally known that the detection depth in XPS measurement is about 10 nm from a sample surface. That is, in the XPS measurement, atoms present in a region (hereinafter referred to as “surface layer”) in a range from the sample surface to the depth of about 10 nm are measured. Therefore, the fact that the [N_{XPS}/C_{XPS}]/[N_{CHN}/C_{CHN}] is 0.7 or more indicates that a large number of nitrogen atoms are present in the surface layer of the sample. Since the nitrogen atom is also an active site, it is presumed that the activity of the catalyst becomes more excellent due to the presence of a large number of nitrogen atoms in the surface layer of the sample.

The carbon material may further contain a metal element. Examples of the metal element include aluminum (Al), titanium (Ti), vanadium (V), chromium (Cr), manganese (Mn), iron (Fe), cobalt (Co), nickel (Ni), copper (Cu), zinc (Zn), niobium (Nb), molybdenum (Mo), ruthenium (Ru), rhodium (Rh), palladium (Pd), silver (Ag), hafnium (Hf), tantalum (Ta), tungsten (W), rhenium (Re), osmium (Os), iridium (Ir), platinum (Pt), gallium (Ga), and gold (Au). The metal element contained in the carbon material may be one type or two or more types. The metal element may be, for example, an element derived from a central metal contained in a phthalocyanine compound serving as a raw material for the carbon material.

In an embodiment, the carbon material may contain Zn as a constituent element. In this case, the oxygen reduction activity, the carbon dioxide reduction activity, and the nitrogen reduction activity tend to be more excellent.

In another embodiment, the carbon material may contain, as a constituent element, at least one metal element (hereinafter referred to as “metal element M1”) selected from the group consisting of Fe, Co, Ni, Cu, and Zn. These metal elements are elements that promote adsorption of gas (oxygen, carbon dioxide, nitrogen) to a surface of the carbon material. When the carbon material contains the metal element M1, the oxygen reduction activity, the carbon dioxide reduction activity, and the nitrogen reduction activity tend to be more excellent. This tendency is remarkable when the metal element M1 is an Fe element, and is more remarkable when the carbon material contains the metal element M1 (particularly, an Fe element) and a Zn element.

A total content of the metal elements may be 0.005 mass % or more, or may be 0.05 mass % or more, 0.1 mass % or more, or 1 mass % or more from the viewpoint of further improving the oxygen reduction activity, the carbon dioxide reduction activity, and the nitrogen reduction activity. The total content of the metal elements may be 20 mass % or less, or may be 5 mass % or less, 2 mass % or less, or 0.1 mass % or less from the viewpoint of further improving the oxygen reduction activity, the carbon dioxide reduction activity, and the nitrogen reduction activity. From the above viewpoint, the total content of the metal elements may be, for example, from 0.005 to 20 mass %.

A total content of the metal elements M1 may be 0.005 mass % or more, or may be 0.03 mass % or more, 0.05 mass % or more, or 1 mass % or more from the viewpoint of further improving the oxygen reduction activity, the carbon dioxide reduction activity, and the nitrogen reduction activity. The total content of the metal elements M1 may be 20 mass % or less, or may be 5 mass % or less, 2 mass % or less, or 0.1 mass % or less from the viewpoint of further improving the oxygen reduction activity, the carbon dioxide reduction activity, and the nitrogen reduction activity. From the above viewpoint, the total content of the metal elements M1 may be, for example, from 0.005 to 20 mass %.

From the viewpoint of further improving the oxygen reduction activity, the carbon dioxide reduction activity, and the nitrogen reduction activity, a content of the Zn element may be 1 ppm by mass or more, or may be 100 ppm by mass or more, 1000 ppm by mass or more, or 10000 ppm by mass or more. The content of the Zn element may be 60000 ppm by mass or less, or may be 45000 ppm by mass or less, or 30000 ppm by mass or less from the viewpoint of further improving the oxygen reduction activity, the carbon dioxide reduction activity, and the nitrogen reduction activity. From the above viewpoint, the content of the Zn element may be, for example, from 1 to 60000 ppm by mass.

A content of the Fe element may be 1 ppm by mass or more, or may be 100 ppm by mass or more, or 500 ppm by mass or more from the viewpoint of further improving the oxygen reduction activity, the carbon dioxide reduction activity, and the nitrogen reduction activity. From the viewpoint of further improving the durability of the carbon material under acidic conditions, the content of the Fe element may be 60000 ppm by mass or less, or may be 2500 ppm by mass or less, 1500 ppm by mass or less, or 1000 ppm by mass or less. From the above viewpoint, the content of the Fe element may be, for example, from 1 to 60000 ppm by mass.

The contents of the metal elements (the total content of the metal elements, the total content of the metal elements M1, the content of the Zn element, and the content of the Fe element) are contents based on a total mass of the carbon material, and are measured by inductively coupled plasma-optical emission spectrometry (ICP-OES). Specific methods for measuring the metal elements by ICP-OES are described in the examples (experimental examples).

The carbon material may further contain chlorine (Cl) as a constituent element. A chlorine content in the carbon material may be 30000 ppm by mass or less, or may be 10000 ppm by mass or less, 5000 ppm by mass or less, 1000 ppm by mass or less, 500 ppm by mass or less, or 100 ppm by mass or less from the viewpoint of easily obtaining more excellent oxygen reduction activity. The chlorine content may be 0 ppm by mass, but may be 10 ppm by mass or more. The chlorine content is measured by the combustion ion chromatograph (CIC) method in the same manner as the bromine content.

The carbon material may be, for example, in a powder form. A median diameter of the carbon material may be, for example, from 0.01 to 50 μm, or may be from 0.01 to 10 μm. The median diameter of the carbon material is a D50 particle diameter measured by a laser diffraction-type particle size distribution measuring device equipped with an air flow-type dry disperser.

An average particle size of the carbon material may be, for example, from 0.01 to 1 μm, may be 0.35 μm or less or 0.1 μm or less, and may be 0.05 m or more. In particular, when the average particle size of the carbon material is from 0.01 to 0.35 μm, more excellent oxygen reduction activity tends to be easily obtained. The average particle size is the average particle size of primary particles (average primary particle size), and can be calculated from an average value of 40 primary particles constituting an aggregate on a two dimensional image obtained by ultrasonically dispersing a sample in cyclohexane and then photographing the sample with a microscope.

The carbon material may have porosity. That is, the carbon material may be a porous carbon material (for example, a porous carbon material in a powder form). The pores of the porous carbon material can be classified into micropores having a pore size (diameter) of less than 2 nm, mesopores having a pore size (diameter) of from 2 to 50 nm, and macropores having a pore size (diameter) of more than 50 nm, according to the IUPAC classification standard. Among these, in a case where the carbon material has micropores and mesopores, the oxygen reduction activity, the carbon dioxide reduction activity, and the nitrogen reduction activity tend to be more excellent. The reason for this is not clear, but it is presumed that a reaction field suitable for the reduction reaction is formed by fine pores such as micropores and mesopores. That is, it is presumed that the reduction reaction is likely to proceed because the gas (oxygen, carbon dioxide, nitrogen) as a reactant enters the fine pores and is diffused in the carbon material, and that ionomers and water as other reactants via protons are also likely to penetrate into the carbon material.

A total volume of the micropores may be 0.03 cm³/g or more, or may be 0.10 cm³/g or more, or 0.20 cm³/g or more, from the viewpoint of easily obtaining an effect of improving the oxygen reduction activity, the carbon dioxide reduction activity, and the nitrogen reduction activity. The total volume of the micropores may be 3.00 cm³/g or less, or may be 1.00 cm³/g or less, or 0.50 cm³/g or less, from the viewpoint of facilitating adsorption of the gas (oxygen, carbon dioxide, nitrogen) as a reactant to the surface of the carbon material. From these viewpoints, the total volume of the micropores may be, for example, from 0.03 to 3.00 cm³/g. The total volume of the micropores is a sum of the volumes of all the micropores in the carbon material, and is measured by a nitrogen gas adsorption method. Specifically, a nitrogen adsorption/desorption test is performed using an automatic specific surface area/pore distribution measuring device “BELSORP-max” available from MicrotracBEL Corp., and the total volume of the micropores can be calculated by a micropore analysis (MP) method using analysis software.

A total volume of the mesopores may be 0.3 cm³/g or more, or may be 0.4 cm³/g or more, or 0.5 cm³/g or more, from the viewpoint of easily obtaining the effect of improving the oxygen reduction activity, the carbon dioxide reduction activity, and the nitrogen reduction activity. The total volume of the mesopores may be 4.0 cm³/g or less, or may be 1.5 cm³/g or less, or 1.0 cm³/g or less, from the viewpoint of facilitating adsorption of the gas (oxygen, carbon dioxide, nitrogen) as a reactant to the surface of the carbon material. From these viewpoints, the total volume of the mesopores may be, for example, from 0.3 to 4.0 cm³/g. The total volume of the mesopores is a sum of the volumes of all the mesopores in the carbon material, and is measured by a nitrogen gas adsorption method. Specifically, a nitrogen adsorption/desorption test is performed using an automatic specific surface area/pore distribution measuring device “BELSORP-max” available from MicrotracBEL Corp., and the total volume of the mesopores can be calculated by a Barrett-Joyner-Halenda (BJH) method using analysis software.

The carbon material may have macropores. A total volume of the macropores may be, for example, from 0.001 to 1 cm³/g.

The porous carbon material tends to have a relatively large specific surface area. The specific surface area increases as the number of the fine pores increases, and therefore, the oxygen reduction activity, the carbon dioxide reduction activity, and the nitrogen reduction activity tend to be more excellent as the specific surface area of the carbon material increases. A specific surface area (BET specific surface area) of the carbon material as measured by a BET one point method may be, for example, 100 m²/g or more, or may be 200 m²/g or more, or 300 m²/g or more. The BET specific surface area may be 2000 m²/g or less, or may be 1500 m²/g or less, or 1000 m²/g or less, from the viewpoint of facilitating adsorption of the gas (oxygen, carbon dioxide, nitrogen) as a reactant to the surface of the carbon material. From these viewpoints, the BET specific surface area may be, for example, from 100 to 2000 m²/g.

The carbon material may have electrical conductivity. In particular, an electrical conductivity of the carbon material may be 0.01 S/cm or more. The electrical conductivity may be 0.10 S/cm or more, or 1.00 S/cm or more. The electrical conductivity may be from 0.01 to 50 S/cm from the viewpoint of improving reaction efficiencies at electrodes. From the same viewpoint, the electrical conductivity may be 20 S/cm or less or 10 S/cm or less. The electrical conductivity is a value measured by, for example, powder resistance measurement. Specific measurement conditions are shown in the examples (experimental examples).

The carbon material can be obtained by firing a raw material (hereinafter, also referred to as “firing raw material”) containing a phthalocyanine compound having bromine (Br) as a substituent (hereinafter, also referred to as “first compound”). In other words, the carbon material may be a fired product of the firing raw material.

The phthalocyanine compound has, for example, a structure represented by the following formula (1) or (2).

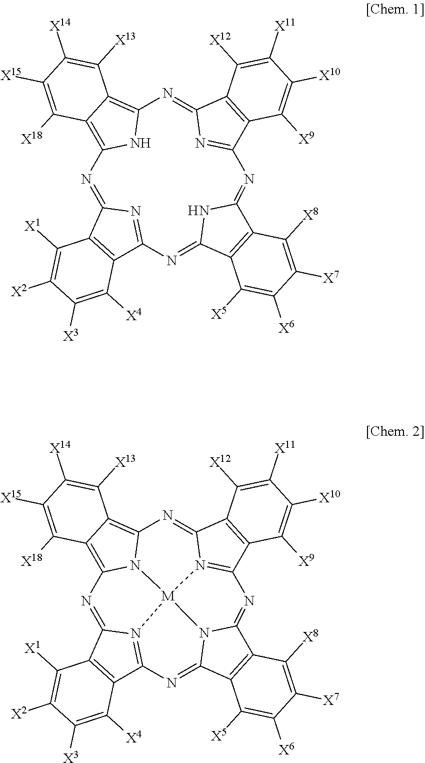

X¹ to X¹⁶ in the formula (1) and the formula (2) each independently represent a hydrogen atom or a halogen atom. However, in the first compound, at least one of X¹ to X¹⁶ in the formulas (1) and (2) is a bromine atom.

M in the formula (2) represents a central metal. Examples of the central metal (M) include Fe, Co, Ni, Cu, and Zn. The phthalocyanine compound having a central metal is sometimes referred to as “iron phthalocyanine” (central metal: Fe), “zinc phthalocyanine” (central metal: Zn), or the like using a prefix corresponding to the type of the central metal.

The first compound may not have the central metal (M), but in a case where the first compound has the central metal (M), a carbon material more excellent in oxygen reduction activity, carbon dioxide reduction activity, and nitrogen reduction activity is likely to be obtained. Furthermore, in a case where the first compound contains Zn as a central metal, that is, in a case where the firing raw material contains zinc phthalocyanine having bromine as a substituent, a carbon material further excellent in oxygen reduction activity, carbon dioxide reduction activity, and nitrogen reduction activity is likely to be obtained.

The halogen atom may be only a bromine atom, or may be a combination of a bromine atom and a halogen atom other than the bromine atom (a fluorine atom, a chlorine atom, and an iodine atom). The halogen atom may include a bromine atom and a chlorine atom.

The firing raw material may contain, as the first compound, a plurality of types of compounds having a structure represented by the formula (1) or formula (2) (for example, a plurality of types of compounds in which the types of X¹ to X¹⁶ are different).

An average number of bromine atoms of the first compound, that is, an average for the number of bromine atoms in the first compound (the number of bromine atoms per molecule) is more than 0, and may be 4 or more (for example, from 4 to 16), may be 5 or more, 8 or more, or 11 or more, and may be 15 or less or 13 or less. When the average number of bromine atoms in the first compound is within the above range, a carbon material having a total volume of the micropores of from 0.03 to 3.00 cm³/g, a total volume of the mesopores of from 0.3 to 4.0 cm³/g, and a BET specific surface area of from 100 to 2000 m²/g is likely to be obtained. The reason for this is not clear, but it is considered that the micropores and the mesopores are formed when some of the bromine atoms are eliminated by firing, and that a carbon material having the surface physical properties corresponding to the number of the bromine atoms is obtained. In addition, although the reason is not clear, it is known that the amounts of pyridine-type nitrogen and quaternary-type nitrogen in the fired product vary depending on the number of bromine atoms in the first compound, and in the case of using zinc phthalocyanine having the above number of bromine atoms, a carbon material having the above-described peak intensity ratio I₂/I₁ of from 0.7 to 3.0 is likely to be obtained. This tendency is remarkable in a case where the firing raw material contains zinc phthalocyanine as the first compound.

An average number of chlorine atoms of the first compound, that is, an average for the number of chlorine atoms in the first compound (the number of chlorine atoms per molecule) may be more than 0 and 11 or less, may be 0.1 or more, 0.5 or more, or 1 or more, and may be 3 or less or 2 or less.

An average number of halogen atoms of the first compound, that is, an average for the total number of halogen atoms in the first compound (the total number of halogen atoms per molecule) is more than 0, and may be from 8 to 16, may be 11 or more, and may be 15 or less or 14 or less.

The number of halogen atoms can be specified by, for example, mass spectrometry using a matrix-assisted laser desorption-ionization time-of-flight mass spectrometer (such as JMS-S3000 available from JEOL Ltd.). Specifically, the number of each halogen atom can be calculated as a relative value per central metal element from a mass ratio between the central metal element and each halogen atom in the first compound.

The first compound may be, for example, in a powder form. An average particle size (average value of major axes of primary particles) of the powder formed of the first compound may be 300 nm or less (for example, from 10 to 300 nm), 200 nm or less (for example, from 10 to 200 nm), 100 nm or less (for example, from 10 to 100 nm), 70 nm or less (for example, from 10 to 70 nm), 60 nm or less (for example, from 10 to 60 nm), or 40 nm or less (for example, from 10 to 40 nm), and may be 40 nm or more (for example, from 40 to 200 nm) or 70 nm or more (for example, from 70 to 200 nm). An average aspect ratio of the powder formed of the first compound may be, for example, from 1.0 to 3.0. The powder having such an average particle size and such an average aspect ratio can be produced by, for example, a method described in WO 2021/220495 or the like.

The firing raw material may be formed of the first compound alone, or may further contain a component other than the first compound. A content of the first compound in the firing raw material may be 50 mass % or more, or may be 80 mass % or more, or 90 mass % or more based on a total mass of the firing raw material from the viewpoint of easily obtaining a carbon material having more excellent oxygen reduction activity, carbon dioxide reduction activity, and nitrogen reduction activity. The content of the first compound in the firing raw material may be 100 mass %, or may be 99 mass % or less, or 95 mass % or less, based on the total mass of the firing raw material.

The firing raw material may further contain a compound containing at least one metal element selected from the group consisting of Ti, V, Cr, Mn, Fe, Co, Ni, Cu, Nb, Mo, Ru, Rh, Pd, Ag, Hf, Ta, W, Re, Os, Ir, Pt, Ga, and Au (hereinafter, also referred to as “second compound”) as a compound other than the first compound. Among these, in the case of using a compound containing at least one metal element selected from the group consisting of Fe, Co, Ni, Cu, Al, and Zn, a carbon material having more excellent oxygen reduction activity, carbon dioxide reduction activity, and nitrogen reduction activity is likely to be obtained. This tendency is remarkable when the central metal of the first compound is Zn, and is more remarkable when the central metal of the second compound is Fe. The second compound is a compound different from the first compound, and is, for example, a compound not containing bromine (Br). One type of the second compound may be used alone, or a plurality of types thereof may be used in combination.

In the second compound, the metal element may be a metal element contained as a central metal of a phthalocyanine compound or a porphyrin compound. That is, the second compound may be a phthalocyanine compound having no bromine as a substituent, or may be a porphyrin compound having no bromine as a substituent. In this case, the phthalocyanine compound and the porphyrin compound may have a halogen element (fluorine, chlorine, or iodine) other than bromine as a substituent.

The second compound may be a metal salt containing the metal element. Examples of the metal salt include sulfates, nitrates, carbonates, phosphates, chromates, metal porphyrin complexes, metal phthalocyanine complexes, alkaline metal salts, alkaline earth metal salts, earth metal salts, transition metal salts, ammonium salts, hydrogen acid salts, and oxo acid salts.

Specific examples of the second compound include metal phthalocyanines such as iron phthalocyanine, cobalt phthalocyanine, nickel phthalocyanine, copper phthalocyanine, and aluminum chloride phthalocyanine, and chlorinated products obtained by substituting some of hydrogen atoms of these with chlorine atoms (any one of X¹ to X¹⁶ in the formula (2) is a chlorine atom); iron tetraphenylporphyrin chloride, tris(dibenzoylmethanato) iron, iron sulfate (for example, iron (II) sulfate-heptahydrate), and iron chloride (for example, iron (III) chloride-hexahydrate, iron (II) chloride-tetrahydrate).

The second compound is, for example, in a powder form. As a powder formed of the second compound is finer, the fired product becomes finer, and more excellent oxygen reduction activity, carbon dioxide reduction activity, and nitrogen reduction activity are easily obtained. From such a viewpoint, an average particle size (average value of major axes of primary particles) of the powder formed of the second compound may be 5000 nm or less (for example, from 10 to 5000 nm), may be 500 nm or less or 200 nm or less, and may be 30 nm or more or 50 nm or more.

Since the content of the metal element, the amount of nitrogen (for example, Nₓₚₛ/Cₓₚₛ and the peak intensity ratio 12/11), and the proportions of pores (micropores and mesopores) in the fired product (carbon material) obtained after firing may vary depending on a content of the second compound in the firing raw material, the content of the second compound may be appropriately set so as to obtain the above-described carbon material in consideration of these variations.

The content of the second compound in the firing raw material may be 0.1 mass % or more, or may be 1 mass % or more, or 5 mass % or more based on a total amount of the first compound and the second compound from the viewpoint of easily obtaining a carbon material having more excellent oxygen reduction activity, carbon dioxide reduction activity, and nitrogen reduction activity. The content of the second compound in the firing raw material may be 35 mass % or less, or may be 20 mass % or less, or 10 mass % or less based on the total amount of the first compound and the second compound from the viewpoint of easily obtaining a carbon material having more excellent oxygen reduction activity, carbon dioxide reduction activity, and nitrogen reduction activity. From these viewpoints, the content of the second compound in the firing raw material may be, for example, from 0.1 to 35 mass % based on the total amount of the first compound and the second compound.

The firing raw material may further contain an organic compound not containing the metal element other than the above ones. Examples of the organic compound include phenol resin, polyfurfuryl alcohol, furan, furan resin, phenol-formaldehyde resin, epoxy resin, polyvinylidene chloride, polythiophene, polysulfone, polyvinyl alcohol, polyvinyl butyral, polyester, polylactic acid, polyether, polyether ether ketone, cellulose, carboxymethyl cellulose, lignin, pitch, polycarbazole, polyacrylic acid, polyacrylic ester, polymethacrylic ester, and polymethacrylic acid. The firing raw material may contain a carbon material such as graphite, activated carbon, amorphous carbon, carbon black, coal, charcoal, coke, carbon nanotube, fullerene, or graphene.

An atmosphere gas during firing may be an inert gas, an oxidizing gas, a reducing gas, or a mixed gas thereof. Examples of the inert gas include argon, helium, and nitrogen. Examples of the oxidizing gas include carbon dioxide. Examples of the reducing gas include hydrogen and ammonia. From the viewpoint of porosity of the resulting carbon material, the atmosphere gas may contain at least one selected from the group consisting of nitrogen, ammonia, and carbon dioxide. For example, an ammonia-containing gas may be used if the specific surface area is to be improved. Mixing helium with ammonia tends to be capable of improving a total volume of either mesopores or micropores. A concentration of ammonia in the ammonia-containing gas may be, for example, from 0.1 to 50 vol %.

A firing temperature may be any temperature at which the firing raw material can be carbonized, and may be, for example, 600° C. or higher. The firing temperature may be 800° C. or higher, or 900° C. or higher. As the firing temperature is higher, a carbon material having a smaller amount of an element other than carbon (nitrogen, a halogen element, a metal element, or the like) tends to be obtained, and the total volumes of micropores and mesopores tend to be larger. The firing temperature may be, for example, 1500° C. or lower from the viewpoint of suppressing high crystallization of the carbon material. From these viewpoints, the firing temperature may be, for example, from 600 to 1500° C. A firing time may be, for example, from 0.5 to 6 hours. The firing may be performed by a one-stage heat treatment or two or more-stage heat treatment. For example, the raw material may be fired by performing the heat treatment at a temperature of 600° C. or higher after the heat treatment at a temperature of lower than 600° C.

When the two or more-stage heat treatment is performed, the second stage may be performed in an atmosphere different from that of the first stage. By setting the gas atmosphere at the second stage different from that at the first stage, the specific surface area, the total volumes of mesopores and micropores, and the like can be easily controlled.

In an embodiment of the present disclosure, the obtained fired product may be cleaned. That is, the fired product of the firing raw material constituting the carbon material may be a fired product after cleaning. The cleaning method is not particularly limited, and examples thereof include water washing, acid cleaning, and alkali cleaning. The cleaning method may be acid cleaning from the viewpoint of controlling the content of the metal element. Examples of the acid include hydrochloric acid and sulfuric acid.

### (Catalyst)

Another embodiment of the present disclosure is a catalyst (for example, an electrode catalyst) including the carbon material of the above embodiment. The catalyst of an embodiment may be an oxygen reduction catalyst, a carbon dioxide reduction catalyst, or a nitrogen reduction catalyst. The oxygen reduction catalyst may be a two-electron reduction catalyst that catalyzes a two-electron reduction reaction of oxygen or may be a four-electron reduction catalyst that catalyzes a four-electron reduction reaction of oxygen. Since the carbon material of the above embodiment exhibits catalytic ability as an oxygen reduction catalyst under both acidic conditions and basic conditions, the oxygen reduction catalyst of the present embodiment can be used under both acidic conditions and basic conditions.

### (Dispersion Liquid)

Another embodiment of the present disclosure is a dispersion liquid containing the carbon material of the above embodiment and a dispersion medium for the carbon material. The dispersion liquid is used for forming an electrode catalyst layer. That is, one aspect of the dispersion liquid is an ink composition for forming an electrode catalyst layer.

As described above, the carbon material of the above embodiment can function as an oxygen reduction catalyst, a carbon dioxide reduction catalyst, or a nitrogen reduction catalyst, and thus the dispersion liquid is useful for forming an electrode catalyst layer for an oxygen reduction electrode (for example, a positive electrode catalyst layer of a fuel cell, an air cell, or the like, and a cathode catalyst layer of an oxygen electrolysis device), an electrode catalyst layer for a carbon dioxide reduction electrode (for example, a cathode catalyst layer of a carbon dioxide electrolysis device), or an electrode catalyst layer for a nitrogen reduction electrode (for example, a cathode catalyst layer of a nitrogen electrolysis device).

As the dispersion medium, a known dispersion medium used for forming an electrode catalyst layer of the cell or the electrolysis device can be used. For example, water, lower alcohols (methanol, ethanol, isopropyl alcohol, normal propyl alcohol, etc.), and mixtures thereof can be used. A content of the dispersion medium may be appropriately adjusted so that a viscosity of the dispersion liquid is suitable for an application device. The content of the dispersion medium in the dispersion liquid may be, for example, from 60 to 99.5 mass % based on a total mass of the dispersion liquid.

The dispersion liquid may be composed only of the carbon material and the dispersion medium, but may contain, in addition to these, a known material used for forming an electrode catalyst layer of the cell or the electrolysis device. The dispersion liquid may further contain, for example, a binder for the carbon material. As the binder, a known organic polymer compound can be used, and a polymer electrolyte may be used from the viewpoint of being capable of forming an ion conductive path. Examples of the polymer electrolyte include perfluorosulfonic acid polymers such as Nafion (registered trademark).

When the dispersion liquid contains solids (for example, the binder) other than the carbon material, the content of the carbon material may be from 40 to 80 mass % based on a total amount of the solids in the dispersion liquid. A content of the binder in the dispersion liquid may be from 20 to 60 mass % based on the total amount of the solids in the dispersion liquid. When the dispersion liquid contains a polymer electrolyte, a content of the polymer electrolyte may be from 20 to 60 mass % based on the total amount of the solids in the dispersion liquid. The total amount of the solids refers to a total amount of components other than the dispersion medium contained in the dispersion liquid.

The dispersion liquid may further contain a carbon material other than the carbon material of the above embodiment. A content of the carbon material other than the carbon material of the above embodiment may be 40 mass % or less based on a total amount of all the carbon materials.

### (Electrode)

Another embodiment of the present disclosure is an electrode including an electrode catalyst layer containing the carbon material of the above embodiment. The electrode may be an oxygen reduction electrode (for example, a positive electrode of a fuel cell or an air cell, or a cathode of an oxygen electrolysis device), may be a carbon dioxide reduction electrode (for example, a cathode of a carbon dioxide electrolysis device), or may be a nitrogen reduction electrode (for example, a cathode of a nitrogen electrolysis device). As the configuration of the electrode other than the electrode catalyst layer, a typically known configuration for an oxygen reduction electrode, a carbon dioxide reduction electrode, a nitrogen reduction electrode, or the like can be adopted. The electrode of an embodiment may further include, for example, a gas diffusion layer, a microporous layer, and the like.

The electrode catalyst layer may be composed only of the carbon material, but may contain a component other than the carbon material depending on the application. Examples of the component other than the carbon material include a binder such as the above-described polymer electrolyte. Ranges of the contents of the carbon material, the binder, and the polymer electrolyte in the electrode catalyst layer (based on a total mass of the electrode catalyst layer) may be the same as the ranges of the contents of the carbon material, the binder, and the polymer electrolyte in the dispersion liquid of the above-described embodiment (based on the total amount of the solids in the dispersion liquid).

The electrode catalyst layer can be formed using the dispersion liquid of the above embodiment. For example, the electrode catalyst layer may be obtained by applying the dispersion liquid onto a support and drying the dispersion liquid. The application method is not particularly limited, and a general method using, for example, a bar coater, a spray coater, or a screen printer can be used.

The electrode may be a part of a membrane electrode assembly (MEA) constituting a fuel cell. The MEA includes, for example, a positive electrode catalyst layer, a negative electrode catalyst layer, an electrolyte membrane disposed between the positive electrode catalyst layer and the negative electrode catalyst layer, and a pair of gas diffusion layers disposed on sides of the positive electrode catalyst layer and the negative electrode catalyst layer opposite to the electrolyte membrane side.

### (Battery)

Another embodiment of the present disclosure is a battery including the electrode of the above embodiment. This battery is, for example, a battery including the electrode of the above embodiment as an oxygen reduction electrode (positive electrode), and may be a fuel cell or an air cell. Examples of the fuel cell include a polymer electrolyte fuel cell (PEFC), a phosphoric acid fuel cell (PAFC), an alkaline fuel cell (AFC), a molten carbonate fuel cell (MCFC), a solid oxide fuel cell (SOFC), and a microbial fuel cell (MFC). As the configuration of the battery other than the positive electrode, a typically known configuration for a fuel cell, an air cell, or the like can be adopted. The battery of an embodiment may be, for example, a fuel cell including a membrane electrode assembly (MEA) including the electrode.

### (Electrolysis Device)

Another embodiment of the present disclosure is an electrolysis device including the electrode of the above embodiment. The electrolysis device may be an electrolysis device (oxygen electrolysis device) including the electrode of the above embodiment as an oxygen reduction electrode (cathode), may be an electrolysis device (carbon dioxide electrolysis device) including the electrode of the above embodiment as a carbon dioxide reduction electrode (cathode), or may be an electrolysis device (nitrogen electrolysis device) including the electrode of the above embodiment as a nitrogen reduction electrode (cathode). The oxygen electrolysis device can also be referred to as a hydrogen peroxide synthesis device because it synthesizes hydrogen peroxide with decomposition of oxygen. As the configuration of the battery other than the cathode, a typically known configuration for an oxygen electrolysis device, a carbon dioxide electrolysis device, a nitrogen electrolysis device, or the like can be adopted.

### EXAMPLES

Hereinafter, the contents of the present disclosure will be described in more detail using experimental examples, but the present disclosure is not limited to the following experimental examples.

### Method for Measuring Number of Halogen Atoms

The number of halogen atoms (average number of bromine atoms and average number of chlorine atoms) of each of materials used in the experimental examples was determined by mass spectrometry using JMS-S3000 available from JEOL Ltd.

### Method for Measuring Average Particle Size

The average particle size of each of the materials used in the experimental examples (average primary particle size) was calculated from an average value of 40 primary particles constituting an aggregate on a two dimensional image obtained by ultrasonically dispersing the material in cyclohexane and then photographing the material with a microscope.

### Experimental Example 1

As a raw material powder A, C.I. Pigment Green 58 (zinc phthalocyanine having bromine and chlorine as substituents, average number of bromine atoms: from 11 to 16, average number of chlorine atoms: from 0 to 5, average particle size: from 10 to 60 nm) available from DIC Corporation was prepared. Then, on a boat for firing (SSA-S 5B, CC brand, available from Nikkato Corporation; alumina: 99.6%), 1.0 g of the raw material powderA was placed, and the boat was placed in the center of a quartz reaction tube. After purging the air remaining in the tube by passing nitrogen gas through the tube for 20 min at 500 ml/min, the temperature was raised to 600° C. (firing temperature) at 10° C./min under a nitrogen flow (500 ml/min) in a tubular furnace, and retained for 2 hours. Thereafter, the mixture was cooled to room temperature under a nitrogen flow, and then a carbon material which was a fired product of the raw material powder A was taken out.

### Experimental Example 2

A carbon material was produced in the same manner as in Experimental Example 1, except that the firing temperature was changed from 600° C. to 900° C.

### Experimental Example 3

A raw material mixture A was prepared by mixing the raw material powder A and iron phthalocyanine (“FePc” in Table 1, available from Tokyo Chemical Industry Co., Ltd., iron (II) phthalocyanine, product code: P0774, average particle size: 110 nm, the same applies hereinafter) at a mass ratio of 10:1. A carbon material was produced in the same manner as in Experimental Example 1 except that the obtained raw material mixture A was used in place of the raw material powder A.

### Experimental Example 4

A carbon material was produced in the same manner as in Experimental Example 3, except that the firing temperature was changed from 600° C. to 900° C.

### Experimental Example 5

The raw material powder A and the iron phthalocyanine were mixed at a mass ratio of 500:1 to prepare a raw material mixture B. A carbon material was produced in the same manner as in Experimental Example 2 except that the obtained raw material mixture B was used in place of the raw material powder A.

### Experimental Example 6

The raw material powder A and the iron phthalocyanine were mixed at a mass ratio of 2:1 to prepare a raw material mixture C. A carbon material was produced in the same manner as in Experimental Example 2 except that the obtained raw material mixture C was used in place of the raw material powder A.

### Experimental Example 7

A raw material mixture D was prepared by mixing the raw material powder A and iron (II) sulfate-heptahydrate (“FeSO₄” in Table 1, available from FUJIFILM Wako Pure Chemical Corporation, average particle size: 430 nm) so that the mass ratio of the raw material powder A to iron (II) sulfate was 10:1. A carbon material was produced in the same manner as in Experimental Example 2 except that the obtained raw material mixture D was used in place of the raw material powder A.

### Experimental Example 8

As a raw material powder B, C.I. Pigment Green 59 (zinc phthalocyanine having bromine and chlorine as substituents, average number of bromine atoms: from 8 to 13, average number of chlorine atoms: from 0 to 5, average particle size: from 10 to 60 nm) available from DIC Corporation was prepared. Then, a carbon material was produced in the same manner as in Experimental Example 5 except that the raw material powder B was used in place of the raw material powder A.

### Experimental Example 9

A carbon material was produced in the same manner as in Experimental Example 2 except that zinc phthalocyanine (“ZnPc” in Table 1) available from DIC Corporation was used in place of the raw material powder A.

### Experimental Example 10

A carbon material was produced in the same manner as in Experimental Example 2 except that iron phthalocyanine was used in place of the raw material powder A.

### Experimental Example 11

A carbon material was produced in the same manner as in Experimental Example 2 except that a mixed gas of ammonia and helium (ammonia concentration: 1 vol %) was used, in place of nitrogen, as the flowing gas.

### Experimental Example 12

A carbon material was produced in the same manner as in Experimental Example 2 except that a mixed gas of ammonia and helium (ammonia concentration: 10 vol %) was used, in place of nitrogen, as the flowing gas.

### Experimental Example 13

A carbon material was produced in the same manner as in Experimental Example 2 except that the carbon material of Experimental Example 2 was used in place of the raw material powder A and that carbon dioxide was used, in place of nitrogen, as the flowing gas.

### Experimental Example 14

A carbon material was produced in the same manner as in Experimental Example 4 except that a mixed gas of ammonia and helium (ammonia concentration: 10 vol %) was used, in place of nitrogen, as the flowing gas.

### Experimental Example 15

In a 110-ml vial, 0.5 g of the carbon material obtained in Experimental Example 4 and 50 ml of 1 mol/L hydrochloric acid were placed, stirred at 70° C. for 1 hour, and then filtered and washed with water. Further, the same operation was repeated twice, and the obtained residue was then dried overnight in an oven at 90° C. to produce a carbon material.

### Experimental Example 16

A carbon material was produced in the same manner as in Experimental Example 15, except that the carbon material obtained in Experimental Example 8 was used in place of the carbon material obtained in Experimental Example 4.

### Analysis

The carbon materials obtained in Experimental Examples 1 to 16 were subjected to composition analysis and physical property analysis. In the following description, the sample means a carbon material to be analyzed.

(Composition Analysis 1: Measurement of Elemental Composition Ratio Nₓₚₛ/Cₓₚₛ and Peak Intensity Ratio I₂/I₁)

The elemental composition ratio Nₓₚₛ/Cₓₚₛ of nitrogen (N) to carbon (C) in a sample was determined by the X-ray photoelectron spectroscopy (XPS). Specifically, first, the sample was filled in a sample holder for measuring powder, available from Thermo Fisher Scientific Inc. so that the sample surface was flat, and XPS measurement (narrow scan measurement for each element) was performed using a K-Alpha model available from Thermo Fisher Scientific Inc., to obtain spectra of nitrogen (N1s) and carbon (C1s). Then, a baseline was determined for the peak of each element by a Shirley method, and the peak area was derived. Specifically, in the spectrum of each element, a baseline was drawn by the Shirley method from an average value of binding energies from the terminal position where a signal was detected to 1.0 eV on the smaller side and an average value of binding energies from the terminal position to 1.0 eV on the larger side, and then the peak area was determined by an integral value of a difference between the peak intensity and the baseline. In the X-ray photoelectron spectroscopy, since the peak area is correlated with the content of each element, the elemental composition ratio Nₓₚₛ/Cₓₚₛ was calculated by comparing the peak areas of the respective elements. The results are presented in Table 1. The above operations and calculations were performed using the measurement/analysis software Avantage attached to the K-Alpha model available from Thermo Fisher Scientific Inc. The measurement conditions for the XPS measurement are shown below.

### Measurement Conditions

Excited X-ray source: Al-Kα ray (hv=1486.6 eV) with monochromator
Charge neutralization: performed
Charge correction: not performed
Photoelectron escape angle (inclination of detector with respect to sample surface): 90°
Current: 6 mA
Voltage: 12 kV
Measured diameter: 400 μm in diameter
Data: 0.1 eV/step
C1 s spectrum measurement range: 279 eV or more and 298 eV or less
N1 s spectrum measurement range: 392 eV or more and 410 eV or less

In addition, the N1s spectrum obtained above was subjected to peak separation in the peak top binding energies of N1-type nitrogen, N2-type nitrogen, and N3-type nitrogen (N1-type: 398.5±0.5 eV, N2-type: 401.2±0.5 eV, and N3-type: 403±1.0 eV), and the peak intensity ratio 12/11 was determined from the peak intensity 11 of the N1-type nitrogen and the peak intensity 12 of the N2-type nitrogen. The results are presented in Table 1.

(Composition Analysis 2: Measurement of Elemental Composition Ratio N_{CHN}/C_{CHN})

The elemental composition ratio N_{CHN}/C_{CHN} of nitrogen (N) to carbon (C) in the sample was determined by CHN elemental analysis by the combustion method based on a Pregl-Dumas method as a basic principle. Specifically, first, the sample was completely combusted and gasified in a high-temperature furnace using MICRO CODER JM10 (available from J-Science Lab. Co., Ltd.). The gas was introduced into a thermal conductivity detector to measure mass concentrations of nitrogen (N) and carbon (C), and these values were divided by their atomic weights to obtain a ratio between the obtained values, thereby determining the elemental composition ratio N_{CHN}/C_{CHN}.

### (Composition Analysis 3: Measurement of Bromine Content and Chlorine Content)

The bromine content (the content rate of the total bromine in the sample) and the chlorine content (the content rate of the total chlorine in the sample) in the sample were measured by the combustion ion chromatograph (CIC) method. Specifically, first, the sample was weighed and then combusted using an automatic sample combustion device, and the generated gas was collected in 5 mL of an absorbent (hydrogen peroxide solution). The absorbent was adjusted to 15 mL with ultrapure water, and quantitative analysis was performed by an ion chromatograph method. In the quantitative analysis, calibration curves of Br- ions and Cl- ions were approximated by measurement of standard substances, and then the sample was measured to quantify the bromine content (ppm by mass) and the chlorine content (ppm by mass) in the sample. The results are presented in Table 1.

The calculation formulas are as follows.

$$Bromine content [ ppm by mass ] = ( Br area in measurement solution - calibration curve intercept ) \text{} / calibration curve slope \times absorbent amount [ mL ] \times dilution rate [ times ] / ( sample collection amount [ mg ] / 1000 )$$

$$Chlorine content [ ppm by mass ] = ( {Cl}^{-} area in measurement solution - calibration curve intercept ) \text{} / calibration curve slope \times absorbent amount [ mL ] \times dilution rate [ times ] / ( sample collection amount [ mg ] / 1000 )$$

(*The measurement solution is 25 μL of the injected sample.)

The details of the analyzer and measurement conditions used for the quantitative analysis are shown below.

### Analyzer

Automatic sample combustion device: “AQF-2100H” available from Mitsubishi Chemical Analytech Co., Ltd.
Ion chromatograph: “ICS-6000” available from Thermo Fisher Scientific Inc.

### Measurement Conditions of Automatic Sample Combustion Device

Temperature; inlet 900° C., outlet 1000° C.
Gas flow rate; oxygen 400 mL/min, argon 200 mL/min, argon water supply unit 100 mL/min

### Measurement Conditions of Ion Chromatograph

Separation column; IonPacAS19 aCailable from Thermo Fisher Scientific Inc.
Guard column; IonPacAS19 available from Thermo Fisher Scientific Inc.
Remov8l system; AERS-500 (external mode)
Detector; electrical conductillty detector
Eluent; aqueous potassium hydroxide solution (eluent generator ECG III was used)
Eluent flow rate; 1 mL/min
Sample injection volume: 25 μL

### (Composition Analysis 4: Measurement of Zinc Content and Iron Content)

In a 110-mL polytetrafluoroethylene sealed container (iPrep, MARS6-dedicated product, available from CEM Corporation, USA) for a microwave decomposition system (MARS6 available from CEM Corporation, USA), 0.25 g of the sample and 8 mL of nitric acid were placed. The sealed container was set in the microwave decomposition system, and pretreated at 250° C. for 20 minutes to decompose the sample. The solution taken out was diluted 100, 1000, and 100000 times with ultrapure water to obtain measurement solutions. Nitric acid was added to a standard solution (mixed solution of 23 elements) for ICP emission spectrometry to prepare samples for calibration curve creation having seven concentrations of 0, 5, 10, 50, 100, 500, and 3000 ppb. The samples for calibration curve creation were measured with a high-frequency inductively coupled plasma-optical emission spectrometer (“Optima 8300” available from PerkinElmer Japan Co., Ltd.) to create calibration curves for the content of the iron element and the zinc element. Thereafter, the measurement solutions formed of the sample decomposition products were measured to calculate the iron content and the zinc content. The results are presented in Table 1.

### (Physical Property Analysis 1: Measurement of BET Specific Surface Area)

The BET specific surface areas of the samples were measured by a nitrogen adsorption method. The measurement was performed by a fully automatic specific surface area measuring device Macsorb HM model-1208 (available from Mountech Co., Ltd.) in accordance with “Method for Measuring Gas Adsorption Amount by One Point Method” specified in Appendix 2 of Japanese Industrial Standard JIS Z8830-1990. The results are presented in Table 1.

### (Physical Property Analysis 2: Measurement of Pore Volume)

The carbon material was placed in a sample tube and pretreated at 100° C. for 2 hours under reduced pressure (10-2 kPa or less) using BELPREP vac II (available from MicrotracBEL Corp.). Thereafter, the sample tube was attached to BELSORP-max, and nitrogen gas was adsorbed/desorbed at −196° C. while changing the relative pressure. The obtained adsorption/desorption isotherm was analyzed with analysis software (available from MicrotracBEL Corp., software name “BELMaster”), the total volume of mesopores was calculated in accordance with the BJH method, and the total volume of micropores was calculated in accordance with the MP method. The results are presented in Table 1.

### (Physical Property Analysis 3: Measurement of Electrical Conductivity)

The electrical conductivities [S/cm] of the samples were measured using an automatic powder resistance measuring system (MCP-PD600 type available from Nittoseiko Analytech Co., Ltd.). The automatic powder resistance measuring system used was composed of a low resistance probe unit, an automatic hydraulic pump, a main body controller, and a low resistivity meter Loresta GX (MCP-T700 type available from Nittoseiko Analytech Co., Ltd.). The volume resistivity [Ω·cm] when the carbon material was put into the low resistance probe unit and then a load of the 12 kN was applied was measured, and a reciprocal thereof was taken as the electrical conductivity [S/cm]. The results are presented in Table 1.

TABLE 1

| | Raw material | | | | | | | | |
|---|---|---|---|---|---|---|---|---|---|
| | | | Mass | | | | | | |
| | | | ratio | | | Composition | | | |
| | | | (raw | | | Elemental | Elemental | Peak | |
| | | | material | | | composition | composition | intensity | Br |
| | Raw | Raw | 1:raw | Firing | | ratio | ratio | ratio | content |
| | material 1 | material 2 | material 2) | temperature | Gas | Nₓₚₛ/Cₓₚₛ | N_{CHN}/C_{CHN} | I₂/I₁ | [ppm] |
| Experimental | Raw material | — | — | 600° C. | N₂ | 0.207 | 0.212 | 0.75 | 89060 |
| Example 1 | powder A | | | | | | | | |
| Experimental | Raw material | — | — | 900° C. | N₂ | 0.090 | 0.112 | 1.79 | 3500 |
| Example 2 | powder A | | | | | | | | |
| Experimental | Raw material | FePc | 10:1 | 600° C. | N₂ | 0.212 | 0.228 | 0.78 | 95250 |
| Example 3 | powder A | | | | | | | | |
| Experimental | Raw material | FePc | 10:1 | 900° C. | N₂ | 0.075 | 0.096 | 1.47 | 13000 |
| Example 4 | powder A | | | | | | | | |
| Experimental | Raw material | FePc | 500:1 | 900° C. | N₂ | 0.076 | 0.101 | 1.79 | 2650 |
| Example 5 | powder A | | | | | | | | |
| Experimental | Raw material | FePc | 2:1 | 900° C. | N₂ | 0.037 | 0.044 | 1.82 | 3520 |
| Example 6 | powder A | | | | | | | | |
| Experimental | Raw material | FeSO4 | 10:1 | 900° C. | N₂ | 0.082 | 0.099 | 1.72 | 10400 |
| Example 7 | powder A | | | | | | | | |
| Experimental | Raw material | FePc | 500:1 | 900° C. | N₂ | 0.090 | 0.104 | 1.64 | 4950 |
| Example 8 | powder B | | | | | | | | |
| Experimental | ZnPc | — | — | 900° C. | N₂ | 0.091 | 0.130 | 0.63 | — |
| Example 9 | | | | | | | | | |
| Experimental | FePc | — | — | 900° C. | N₂ | 0.025 | 0.005 | 0.80 | — |
| Example 10 | | | | | | | | | |
| Experimental | Raw material | — | — | 900° C. | 1% | 0.096 | 0.130 | 1.00 | 5400 |
| Example 11 | powder A | | | | NH₃ | | | | |
| Experimental | Raw material | — | — | 900° C. | 10% | 0.104 | 0.146 | 0.92 | 4000 |
| Example 12 | powder A | | | | NH₃ | | | | |
| Experimental | Experimental | — | — | 900° C. | CO₂ | 0.079 | 0.096 | 1.73 | 2200 |
| Example 13 | Example 2 | | | | | | | | |
| Experimental | Raw material | FePc | 10:1 | 900° C. | 10% | 0.089 | 0.118 | 0.96 | 3700 |
| Example 14 | powder A | | | | NH₃ | | | | |
| Experimental | Experimental | — | — | — | — | 0.073 | 0.095 | 1.44 | 13000 |
| Example 15 | Example 4 | | | | | | | | |
| Experimental | Experimental | — | — | — | — | 0.093 | 0.106 | 1.62 | 4920 |
| Example 16 | Example 8 | | | | | | | | |

| | | | | Physical properties | | | |
|---|---|---|---|---|---|---|---|
| | | | | BET | | | |
| | Composition | | | specific | Total | Total | |
| | Cl | Zn | Fe | surface | micropore | mesopore | Electrical |
| | content | content | content | area | volume | volume | conductivity |
| | [ppm] | [ppm] | [ppm] | [m²/g] | [cm³/g] | [cm³/g] | [S/cm] |
| Experimental | 21990 | 48000 | — | 130 | 0.053 | 0.529 | 0.027 |
| Example 1 | | | | | | | |
| Experimental | 80 | 26000 | — | 285 | 0.201 | 0.740 | 6.757 |
| Example 2 | | | | | | | |
| Experimental | 3840 | 30000 | 18000 | 401 | 0.231 | 0.483 | 0.056 |
| Example 3 | | | | | | | |
| Experimental | 70 | 270 | 32000 | 498 | 0.274 | 0.493 | 0.505 |
| Example 4 | | | | | | | |
| Experimental | 350 | 12000 | 2300 | 348 | 0.148 | 0.738 | 6.506 |
| Example 5 | | | | | | | |
| Experimental | 40 | 2.6 | 42000 | 522 | 0.170 | 0.318 | 7.929 |
| Example 6 | | | | | | | |
| Experimental | 820 | 4.3 | 34000 | 507 | 0.127 | 0.785 | 6.290 |
| Example 7 | | | | | | | |
| Experimental | 180 | 15000 | 1300 | 527 | 0.132 | 0.567 | 3.047 |
| Example 8 | | | | | | | |
| Experimental | — | 120000 | — | 14 | 0.021 | 0.014 | 27.931 |
| Example 9 | | | | | | | |
| Experimental | — | — | 130000 | 181 | 0.016 | 0.190 | 72.483 |
| Example 10 | | | | | | | |
| Experimental | 60 | 12000 | — | 734 | 0.347 | 0.954 | 5.361 |
| Example 11 | | | | | | | |
| Experimental | 40 | 9000 | — | 1009 | 0.613 | 2.038 | 4.948 |
| Example 12 | | | | | | | |
| Experimental | 60 | 24000 | — | 387 | 0.230 | 0.855 | 6.552 |
| Example 13 | | | | | | | |
| Experimental | 40 | 110 | 29000 | 1390 | 0.571 | 1.915 | 1.274 |
| Example 14 | | | | | | | |
| Experimental | 50 | 90 | 9100 | 475 | 0.267 | 0.473 | 0.483 |
| Example 15 | | | | | | | |
| Experimental | 180 | 7300 | 540 | 502 | 0.125 | 0.573 | 3.009 |
| Example 16 | | | | | | | |

### Evaluations

### (Evaluation of Oxygen Reduction Activity)

### Acidic Conditions

The oxygen reduction activity of the carbon materials of Experimental Examples 1 to 16 under acidic conditions was evaluated by the following method. As a reference example, the oxygen reduction activity of platinum-supporting carbon of platinum-supporting carbon (trade name: TEC10E10E, available from TANAKA PRECIOUS METAL TECHNOLOGIES Co., Ltd.), which has been typically used as a catalyst for an oxygen reduction electrode of a fuel cell, was also evaluated.

First, 4.1 mg of the carbon material or platinum-supporting carbon, 1680 μL of IPA (isopropyl alcohol), 420 μL of ultrapure water, and 30 μL of 5% Nafion (Sigma-Aldrich Co. LLC; product number: 510211) were weighed in a □ial and mixed by irradiation with ultrasonic waves for 5 minutes to obtain a dispersion liquid. Four (4) μL of the dispersion liquid was added dropwise to a disk portion of a platinum ring GC disk electrode (RRDE) (BAS Inc., product number: 012613, ring portion outer diameter: 7.0 mm, ring portion inner diameter: 5.0 mm, disk portion outer diameter: 4.0 mm), and allowed to stand for about 10 minutes and dried. This operation was performed twice in total, and 8 μL in total of the dispersion liquid was applied to obtain a catalyst electrode for measurement (disk electrode area: 0.126 cm², amount of catalyst supported: 123 μg/cm²).

Next, the oxygen reduction activity of the catalyst electrode for measurement was evaluated by a three-electrode electrochemical cell method using an Ag/AgCl electrode (BAS Inc.; product number: 012167) as a reference electrode and a Pt coil electrode (BAS Inc.; product number: 012961) as a counter electrode. In particular, the measurement system was first stabilized by cycling in a range of from −0.1 to 0.7 V (vs. Ag/AgCl) at a scanning speed of 100 mV/s in a 0.1 M aqueous HClO₄ solution saturated with nitrogen (N₂). Next, a linear sweep voltammetric (LSV) measurement was performed in a 0.1 M aqueous HClO₄ solution saturated with oxygen (O₂) while rotating the catalyst electrode for measurement at 1600 rpm. The LSV measurement was performed by scanning in a range of from −0.1 to 0.7 V (vs. Ag/AgCl) from a noble potential to a base potential at 10 mV/s.

A voltammogram obtained by measurement with the Ag/AgCl electrode was converted to the RHE reference based on the following formula (a), and a disk current value I_{Disk} and a reaction onset potential Eₒₙₛₑₜ at 0.2 V (vs. RHE) were determined. In the following equation (a), E_{observed} is a potential based on the Ag/AgCl electrode, and E⁰_{Ag/AgCl} was 0.195 and the pH was 1.0.

$${E}_{RHE} = {E}_{Ag / AgCl}^{0} + 0.059 pH + {E}_{observed} \qquad ( a )$$

In this evaluation, the potential at which 0.1 mA/cm² of a reduction current flows was defined as the reaction onset potential, and when the disk current value I_{Disk} at 0.2 V (vs. RHE) was −1.5 mA/cm² or less and the reaction onset potential was 0.5 V or more, the carbon material was determined to have oxygen reduction activity under acidic conditions, and when the disk current value I_{Disk} at 0.2 V (vs. RHE) was −4.0 mA/cm² or less and the reaction onset potential was 0.7 V or more, the carbon material was determined to have excellent oxygen reduction activity under acidic conditions. The results are presented in Table 2.

TABLE 2

| | I_{Disk} | Eₒₙₛₑₜ |
|---|---|---|
| | V = 0.2 V (RHE) | A = −0.1 mA/cm² |
| | [mA/cm²] | [V] |
| Experimental Example 1 | −2.3 | 0.56 |
| Experimental Example 2 | −3.2 | 0.65 |
| Experimental Example 3 | −3.7 | 0.67 |
| Experimental Example 4 | −4.9 | 0.82 |
| Experimental Example 5 | −4.9 | 0.79 |
| Experimental Example 6 | −5.2 | 0.82 |
| Experimental Example 7 | −4.7 | 0.79 |
| Experimental Example 8 | −3.6 | 0.75 |
| Experimental Example 9 | −0.1 | — |
| Experimental Example 10 | −1.3 | 0.58 |
| Experimental Example 11 | −4.0 | 0.80 |
| Experimental Example 12 | −4.2 | 0.81 |
| Experimental Example 13 | −3.4 | 0.68 |
| Experimental Example 14 | −5.5 | 0.89 |
| Experimental Example 15 | −5.0 | 0.83 |
| Experimental Example 16 | −3.8 | 0.77 |
| Reference Example 1 | −5.5 | 0.89 |

### Basic Conditions

The oxygen reduction activity of the carbon materials of Experimental Examples 1 to 8 and 11 to 16 under basic conditions was evaluated in the same manner as in the measurement method under acidic conditions described above, except that a 0.1 M aqueous KOH solution was used in place of the 0.1 M aqueous HClO₄ solution, and that the range of from −0.1 to 0.7 V (vs. Ag/AgCl) was changed to a range of from −0.7 to 0.1 V (vs. Ag/AgCl). However, the value substituted for pH in the above equation (a) for converting the voltammogram to the RHE reference was 13.

In this evaluation, the potential at which 0.1 mA/cm² of a reduction current flows was defined as the reaction onset potential, and when the disk current value I_{Disk} at 0.4 V (vs. RHE) was −2.0 mA/cm² or less and the reaction onset potential was 0.7 V or more, the carbon material was determined to have oxygen reduction activity under basic conditions, and when the disk current value I_{Disk} at 0.4 V (vs. RHE) was −3.5 mA/cm² or less and the reaction onset potential was 0.85 V or more, the carbon material was determined to have excellent oxygen reduction activity under basic conditions. The results are presented in Table 3.

TABLE 3

| | I_{Disk} | Eₒₙₛₑₜ |
|---|---|---|
| | V = 0.4 V (RHE) | A = −0.1 mA/cm² |
| | [mA/cm²] | [V] |
| Experimental Example 1 | −2.8 | 0.79 |
| Experimental Example 2 | −3.4 | 0.87 |
| Experimental Example 3 | −3.9 | 0.85 |
| Experimental Example 4 | −4.9 | 0.97 |
| Experimental Example 5 | −4.1 | 0.78 |
| Experimental Example 6 | −3.8 | 0.96 |
| Experimental Example 7 | −5.3 | 0.95 |
| Experimental Example 8 | −4.2 | 0.87 |
| Experimental Example 11 | −4.4 | 0.89 |
| Experimental Example 12 | −4.5 | 0.90 |
| Experimental Example 13 | −4.0 | 0.81 |
| Experimental Example 14 | −5.6 | 0.99 |
| Experimental Example 15 | −5.0 | 0.98 |
| Experimental Example 16 | −4.1 | 0.79 |

### (Evaluation of Carbon Dioxide Reduction Activity)

The carbon dioxide reduction activity of the carbon materials of Experimental Examples 1 to 16 was evaluated by the following method.

First, a catalyst electrode for measurement was produced in the same manner as in the evaluation of the oxygen reduction activity. Next, the carbon dioxide reduction activity of the catalyst electrode for measurement was evaluated by a three-electrode electrochemical cell method using an Ag/AgCl electrode (BAS Inc.; product number: 012167) as a reference electrode and a Pt coil electrode (BAS Inc.; product number: 012961) as a counter electrode. Specifically, first, the measurement system was stabilized by cycling in a range of from −1.8 to −0.7 V (vs. Ag/AgCl) at a scanning speed of 100 mV/s in a 0.5 M aqueous KHCO₃ (potassium hydrogen carbonate) solution saturated with argon (Ar), and then the LSV measurement was performed while rotating the catalyst electrode for measurement at 1600 rpm to obtain a voltammogram. Next, a voltammogram was obtained by performing LSV measurement while rotating the catalyst electrode for measurement at 1600 rpm in a 0.5 M aqueous KHCO₃ solution saturated with carbon dioxide (CO₂). The LSV measurement was performed by scanning in a range of from −0.8 to −0.1 V (vs. RHE) from a noble potential to a base potential at 5 mV/s. The voltammogram under argon saturation was subtracted from the voltammogram under carbon dioxide saturation to obtain a voltammogram of the carbon dioxide reduction reaction, and the obtained voltammogram was converted to the RHE reference based on the above equation (a) to obtain a current value at −0.7 V (vs. RHE). However, the value substituted for pH in the above equation (a) for converting the voltammogram to the RHE reference was 8.36. In the voltammogram of the carbon dioxide reduction reaction, the larger the current value in the negative direction, the higher the carbon dioxide reduction activity.

In this evaluation, the carbon material was determined to have carbon dioxide reduction activity (Evaluation A or B) when the current value at −0.7 V (vs. RHE) was −0.05 mA/cm² or less in the voltammogram of the carbon dioxide reduction reaction, and the carbon material was determined to have excellent carbon dioxide reduction activity (Evaluation A) when the current value at −0.7 V (vs. RHE) was less than −0.4 mA/cm² in the voltammogram of the carbon dioxide reduction reaction. The evaluation results are shown in Table 4. The evaluation result of the experimental example in which the carbon material was determined not to have carbon dioxide reduction activity was ranked as C.

### (Evaluation of Nitrogen Reduction Activity)

The nitrogen reduction activity of the carbon materials of Experimental Examples 1 to 16 was evaluated by the following method.

First, a catalyst electrode for measurement was produced in the same manner as in the evaluation of the oxygen reduction activity. Next, the nitrogen reduction activity of the catalyst electrode for measurement was evaluated by a three-electrode electrochemical cell method using an Ag/AgCl electrode (BAS Inc.; product number: 012167) as a reference electrode and a Pt coil electrode (BAS Inc.; product number: 012961) as a counter electrode. Specifically, first, the measurement system was stabilized by cycling in a range of from −1.7 to −0.5 V (vs. Ag/AgCl) at a scanning speed of 100 mV/s in a 0.1 M aqueous Na₂SO₄ (sodium sulfate) solution saturated with argon (Ar), and then the LSV measurement was performed while rotating the catalyst electrode for measurement at 1600 rpm to obtain a voltammogram. Next, a voltammogram was obtained by performing LSV measurement while rotating the catalyst electrode for measurement at 1600 rpm in a 0.1 M aqueous Na₂SO₄ solution saturated with nitrogen (N2). The LSV measurement was performed by scanning in a range of from −0.8 to 0 V (vs. RHE) from a noble potential to a base potential at 5 mV/s. The voltammogram under argon saturation was subtracted from the voltammogram under nitrogen saturation to obtain a voltammogram of the nitrogen reduction reaction, and the obtained voltammogram was converted to the RHE reference based on the above equation (a) to obtain a current value at −0.8 V (vs. RHE). However, the value substituted for pH in the above equation (a) for converting the voltammogram to the RHE reference was 5.8. In the voltammogram of the nitrogen reduction reaction, the larger the current value in the negative direction, the higher the nitrogen reduction activity.

In this evaluation, the carbon material was determined to have nitrogen reduction activity (Evaluation A or B) when the current value at −0.8 V (vs. RHE) was −0.02 mA/cm² or less in the voltammogram of the nitrogen reduction reaction, and the carbon material was determined to have excellent nitrogen reduction activity (Evaluation A) when the current value at −0.8 V (vs. RHE) was less than −0.3 mA/cm² in the voltammogram of the nitrogen reduction reaction. The results are shown in Table 4. The evaluation result of the experimental example in which the carbon material was determined not to have nitrogen reduction activity was ranked as C.

TABLE 4

| | CO₂ | N₂ |
|---|---|---|
| | reduction | reduction |
| | activity | activity |
| Experimental Example 1 | C | C |
| Experimental Example 2 | B | A |
| Experimental Example 3 | B | C |
| Experimental Example 4 | A | A |
| Experimental Example 5 | C | C |
| Experimental Example 6 | A | A |
| Experimental Example 7 | A | C |
| Experimental Example 8 | C | C |
| Experimental Example 9 | C | C |
| Experimental Example 10 | C | C |
| Experimental Example 11 | B | A |
| Experimental Example 12 | B | A |
| Experimental Example 13 | B | A |
| Experimental Example 14 | A | A |
| Experimental Example 15 | A | A |
| Experimental Example 16 | C | C |

1. A carbon material comprising at least carbon, nitrogen, and bromine as constituent elements, wherein
a bromine content as measured by a combustion ion chromatograph method is from 50 to 100000 ppm by mass, and
the number of carbon atoms Cₓₚₛ and the number of nitrogen atoms Nₓₚₛ, both of which are quantified by X-ray photoelectron spectroscopy, satisfy 0.005≤Nₓₚₛ/Cₓₚₛ≤0.300.

2. The carbon material according to claim 1, wherein the carbon material comprises at least one metal element selected from the group consisting of Fe, Co, Ni, Cu, and Zn as a constituent element.

3. The carbon material according to claim 2, wherein a total content of the metal elements as measured by inductively coupled plasma-optical emission spectrometry is from 0.005 to 20 mass %.

4. The carbon material according to claim 2, wherein a content of the Fe element as measured by inductively coupled plasma-optical emission spectrometry is from 1 to 60000 ppm by mass.

5. The carbon material according to claim 2, wherein a content of the Zn element as measured by inductively coupled plasma-optical emission spectrometry is from 1 to 60000 ppm by mass.

6. The carbon material according to claim 1, wherein in an Nis spectrum as measured by X-ray photoelectron spectroscopy, a peak intensity I₁ at 398.5±0.5 eV and a peak intensity I₂ at 401.2±0.5 eV satisfy 0.7≤I₂/I₁≤3.0.

7. The carbon material according to claim 1, wherein the number of carbon atoms C_{CHN} and the number of nitrogen atoms N_{CHN}, both of which are quantified by CHN elemental analysis using a combustion method, satisfy 0.005≤N_{CHN}/C_{CHN}≤0.300.

8. The carbon material according to claim 1, wherein the carbon material is a powdery material having porosity.

9. The carbon material according to claim 8, wherein a specific surface area as measured by a BET one point method is from 100 to 2000 m²/g.

10. The carbon material according to claim 8, wherein
the carbon material has micropores having a pore size of less than 2 nm, and
a total volume of the micropores as measured by a nitrogen gas adsorption method is from 0.03 to 3.00 cm³/g.

11. The carbon material according to claim 8, wherein
the carbon material has mesopores having a pore size of from 2 to 50 nm, and
a total volume of the mesopores as measured by a nitrogen gas adsorption method is from 0.3 to 4.0 cm³/g.

12. The carbon material according to claim 1, wherein an electrical conductivity is from 0.01 to 50 S/cm.

13. The carbon material according to claim 1, wherein the carbon material is a fired product of a raw material comprising a phthalocyanine compound having bromine as a substituent.

14. The carbon material according to claim 13, wherein the phthalocyanine compound comprises Zn as a central metal.

15. The carbon material according to claim 13, wherein the raw material further comprises a compound comprising at least one metal element selected from the group consisting of Fe, Co, Ni, Cu, Al, and Zn.

16. A catalyst comprising the carbon material described in claim 1.

17. A dispersion liquid comprising the carbon material described in claim 1 and a dispersion medium for the carbon material.

18. (canceled)

19. An electrode comprising an electrode catalyst layer comprising the carbon material described in claim 1.

20. A battery comprising the electrode described in claim 19.

21. An electrolysis device comprising the electrode described in claim 19.
